(19) United States
(12) Patent Application Publication
(10) Pub. No.: US 2016/0240874 A1
(43) Pub. Date: Aug. 18, 2016

(54) FUEL CELL GENERATOR AND METHOD FOR OPERATING FUEL CELL GENERATOR

(71) Applicant: Mitsubishi Hitachi Power Systems, Ltd., Yokohama-shi (JP)

(72) Inventors: Shigenori Suemori, Tokyo (JP); Yoshinori Kobayashi, Kanagawa (JP); Kenichi Hiwatashi, Kanagawa (JP)

(73) Assignee: Mitsubishi Hitachi Power Systems, Ltd., Yokohama-shi (JP)

(21) Appl. No.: 14/864,321

(22) Filed: Sep. 24, 2015

(30) Foreign Application Priority Data
Feb. 16, 2015 (JP) 2015-028083

(51) Int. Cl. H01M 8/04; H01M 8/10

(52) U.S. Cl. CPC H01M 8/04291; H01M 8/10; H01M 2300/0065

(57) ABSTRACT

To provide a fuel cell generator capable of reducing or repairing damage damaged portions for itself and a method for operating the fuel cell generator.

A fuel cell generator 1 of the present invention includes a fuel cell module 10 formed by disposing multiple power generation elements, in which fuel electrode, a solid electrolyte, and an air electrode are sequentially stacked together, at predetermined intervals, the multiple power generation elements being connected to each other through an interconnector, a fuel supply unit 12 that supplies fuel gas to the fuel electrode; an air supply unit 11 that supplies oxidizing gas to the air electrode; and a repairing particle supply unit 14 that supplies repairing particles 14a to the damaged portion in at least one of the interconnector and the solid electrolyte.

### TECHNICAL FIELD

The present invention relates to a fuel cell generator and a method for operating a fuel cell generator and, for example, relates to a fuel cell generator capable: of self-repairing damage in a cell stack and a method for operating the fuel cell generator.

### BACKGROUND ART

In the related art, a solid oxide fuel cell (SOFC) in which multiple fuel cells (power generation elements) including a fuel electrode, a solid electrolyte, and an air electrode sequentially stacked together therein are disposed on the exterior surface of cylindrical base body tube has been proposed (for example, refer to Patent Document 1). In addition, a solid oxide fuel cell in which multiple fuel cells including a fuel electrode, a solid electrolyte, and an air electrode sequentially stacked together therein are provided on a planar base body plate (for example, refer to Patent Document 2) and a solid oxide fuel cell in which multiple fuel cells including a fuel electrode, a solid electrolyte, and an air electrode sequentially stacked together therein are provided on a base body tube having an elliptical sectional shape (for example, refer to Patent Document 3) have been proposed.

### RELATED ART DOCUMENT

### Patent Document

[Patent Document 1] JP-A-2007-109598

[Patent Document 2] JP-A-2003-272658

[Patent Document 3] JP-A-2013-211106

### SUMMARY OF THE INVENTION

### Problem That the Invention is to Solve

Meanwhile, in the fuel electrode in an ordinary solid oxide fuel cell, since nickel (Ni) is used, when an oxidizing atmosphere of an oxygen partial pressure or higher at which nickel (Ni) oxidizes is formed in the fuel electrode, nickel (Ni) in the fuel electrode oxidizes and thus turns into nickel oxide (NiO) and thus there are cases in which the volume of the fuel electrode expands and thus damaged portions (for example, fissures and the like) are generated in the fuel cell. When damaged portions are generated in the fuel cell, a certain amount of oxidizing gas leaks from the air electrode toward the fuel electrode and thus the damaged portions in the fuel cell enlarge and there are cases in which secondary damage develops in peripheral cell stacks in a cartridge. Therefore, there has been a demand for a fuel cell generator capable of repairing damaged portions even in a case in which the fuel cell is damaged.

The present invention has been made in consideration of the above-described circumstances and an object of the present invention is to provide a fuel cell generator capable of reducing or repairing damage in damaged portions for itself even in a case in which a fuel cell is damaged and a method for operating the fuel cell generator.

### Means for Solving the Problem

A fuel cell generator of the present invention includes a fuel cell main body formed by disposing multiple power generation elements, in which a fuel electrode, a solid electrolyte, and an air electrode are sequentially stacked together, at predetermined intervals, the multiple power generation elements being connected to each other through an interconnector; a fuel gas supply unit that supplies fuel gas to the fuel electrode; an oxidizing gas supply unit that supplies oxidizing gas to the air electrode; and a repairing particle supply unit that supplies repairing particles that repair a damaged portion to the damaged portion in at least one of the interconnector and the solid electrolyte.

According to the fuel cell generator, even in a case in which damaged portions such as fissures are generated in the interconnector and the solid electrolyte of the fuel cell base body, the repairing particles are supplied to the damaged portions and thus it is possible to repair the damaged portions in the interconnector and the solid electrolyte. Therefore, even in a case in which the power generation element is damaged due to the generation of fissures and the like, it is possible to realize a fuel cell generator capable of reducing or repairing damage of the damaged portions for itself.

In the fuel cell generator of the present invention, the repairing particle supply unit preferably supplies the repairing particles to the fuel gas. With this configuration, even in a case in which damaged portions such as fissures are generated in the interconnector and the solid electrolyte of the fuel cell base body, the repairing particles supplied to the fuel gas are supplied to the damaged portions together with the fuel gas and thus it is possible to repair the damaged portions in the interconnector and the solid electrolyte.

In the fuel cell generator of the present invention, the repairing particle supply unit is preferably a repairing particle layer provided on the surface of a base body provided with the power generation element. With this configuration, the repairing particles included in the repairing particle: layer near the damaged portions in the interconnector and the solid electrolyte of the fuel cell main body having a temperature that is increased due to the leakage of the fuel gas are supplied to the damaged portions and thus it becomes possible to efficiently repair the damaged portions.

The fuel cell generator of the present invention preferably includes a control unit that controls the supplied amount of the repairing particles on the basis of an increase in the temperature of the fuel cell base body, the concentration of the fuel gas discharged from the fuel cell base body, the voltage drop of the fuel cell base body, and the concentration of oxygen in the oxidizing gas discharged from the fuel cell base body. With this configuration, the supplied amount of the repairing particles is controlled on the basis of the temperature of the fuel cell base body, the concentration of the fuel gas, the voltage drop of the fuel cell base body, and the concentration of oxygen in the air discharged from the fuel cell base body, which vary depending on the damage, to the power generation element, and thus it becomes possible to efficiently supply the repairing particles depending on the generation of damage in the power generation element. and the degree of the damage.

In the fuel cell generator of the present invention, the repairing particles are preferably at least partially gasified at a temperature that is equal to or higher than the temperature of the interconnector or the solid electrolyte during the repairing operation of the fuel cell main body through which the damaged portions are repaired. With this configuration, the repairing particles supplied to the power generation element in the fuel cell generator base body together with the fuel gas are gasified in the fuel cell base body and thus it becomes possible to supply the repairing particles to the damaged portions in a gaseous state as a volatile component. In addition, the repairing particles as the volatile component supplied to the damaged portions are precipitated in a solid form on the basis of the difference in the oxygen partial pressure between the fuel electrode and the air electrode. As a result, it is possible to supply the repairing particles to the damaged portions through a porous ceramic member or the like and thus it becomes possible to efficiently repair the damaged portions.

In the fuel cell generator of the present invention, the repairing particles are preferably at least partially melted at a temperature that is equal to or higher than the temperature of the interconnector or the solid electrolyte during the repairing operation of the fuel cell main body through which the damaged portions are repaired. With this configuration, the repairing particles supplied to the power generation element in the fuel cell generator base body together with the fuel gas are melted in the damaged portions having a temperature that is increased to the operation temperature or higher of the fuel cell main body due to the leakage of the fuel gas and thus it becomes possible to reduce the leakage of the fuel gas from the damaged portions. In addition, the temperatures of the damaged portions are decreased due to the reduction of the leakage of the fuel gas from the damaged portions and the repairing particles change to a solid and thus it becomes possible to efficiently repair the damaged portions.

In the fuel cell generator of the present invention, the average particle diameter of the repairing particles is preferably 2.5 μm or less. With this configuration, the repairing particles efficiently accompany the fuel gas and it becomes possible to efficiently supply the repairing particles to the damaged portions.

In the fuel cell generator of the present invention, the repairing particles preferably include at least one selected from a group consisting of sodium carbonate, sodium chloride, zinc oxide, sodium fluoride, and sodium silicate. With this configuration, the temperature for the melting or decomposition and precipitation of the repairing particles falls into an appropriate range and thus it becomes possible to efficiently prevent the damaged portions.

In the fuel cell generator of the present invention, the base body is preferably a base body tube forming a cylindrical shape. With this configuration, the balance between the disposition of the fuel cell and the supply of the fuel gas and the air gas efficiently improves and thus it becomes possible to efficiently generate power.

A method for operating a fuel cell generator of the present invention includes a first step of measuring at least one of an increase in the temperature of a fuel cell base body, the concentration of fuel gas discharged from the fuel cell base body, the voltage drop of the fuel cell base body, and the concentration of oxygen in oxidizing gas discharged from the fuel cell base body; and a second step of controlling the amount of repairing particles repairing a damaged portion supplied to the damaged portion in at least one of an interconnector and a solid electrolyte in a power generation element of the fuel cell main body on the basis of at least one measurement value of the measured increase in the temperature, the measured concentration of the fuel gas, the measured voltage drop, and the measured concentration of oxygen.

According to the method for operating a fuel cell generator, the supplied amount of the repairing particles is controlled on the basis of the temperature of the fuel cell base body, the concentration of the fuel gas, the voltage drop of the fuel cell base body, and the concentration of oxygen in the air discharged from the fuel cell base body, which vary depending on the damage to the power generation element, and thus, even in a case in which damaged portions such as fissures are generated in the interconnector and the solid electrolyte of the fuel cell base body, the repairing particles are efficiently supplied and the damaged portions in the interconnector and the electrolyte can be repaired. Therefore, even in a case in which the power generation element is damaged due to the generation of fissures, it is possible to realize a method for operating a fuel cell generator which is capable of reducing or repairing damage of the damaged portions for itself.

In the method for operating a fuel cell generator of the present invention, it is preferable that, in a case in which the measurement value exceeds a predetermined threshold value, the supply of the repairing particles is initiated or continued and, in a case in which the measurement value is equal to or lower than the predetermined threshold value, the supply of the repairing particles is stopped. With this method, it becomes possible to appropriately supply the repairing particles depending on the generation of damaged portions in the interconnector and the solid electrolyte of the fuel cell base body.

In the method for operating a fuel cell generator of the present invention, it is preferable that, in the first step, the supply of the repairing particles is initiated in advance before the initiation of the operation of the fuel cell main body and, in the second step, in a case in which the measurement value exceeds the predetermined threshold value, the supplied amount of the repairing particles is increased and, in a case in which the measurement value is equal to or lower than the predetermined threshold value, the supplied amount of the repairing particles is decreased. With this method, it is possible to supply the repairing particles to the interconnector, the solid electrolyte, and the like of the fuel cell main body at all times and thus it becomes possible to efficiently prevent the generation of the damaged portions.

In the method for operating a fuel cell generator of the present invention, it is preferable that, in the second step, in a case in which the measurement value exceeds the predetermined threshold value, the power generation of the fuel cell main body is stopped so as to initiate or continue the supply of the repairing particles and, furthermore, the method includes a third step of, in a state in which the power generation of the fuel cell main body is stopped, measuring at least one of an increase in the temperature of the fuel cell base body, the concentration of the fuel gas discharged from the fuel cell base body, the voltage drop of the fuel cell base body, and the concentration of oxygen in oxidizing gas discharged from the fuel cell base body; and a fourth step of initiating or continuing the supply of the repairing particles in a case in which at least one measurement value of an increase in the temperature of the fuel cell base body, the concentration of the fuel as discharged from the fuel cell base body, the voltage drop of the fuel cell base body, and the concentration of oxygen in oxidizing gas discharged from the fuel cell main body in a state in which the power generation of the fuel cell main body is stopped exceeds the predetermined threshold value, and stopping the supply of the repairing particles in a case in which the measurement value is equal to or lower than the predetermined threshold value. With this method, even in a case in which the damaged portions such as fissures in the interconnector and the solid electrolyte are large, it is possible to prevent an excessive increase in the temperature of a fuel cell module and thus it becomes possible to efficiently reduce or repair damage for itself using the repairing particles.

In the method for operating a fuel cell generator of the present invention, it is preferable that, in the first step, the supply of the repairing particles is initiated in advance before the initiation of the operation of the fuel cell base body. With this method, it is possible to supply the repairing particles to the interconnector, the solid electrolyte, and the like of the fuel cell main body at all times and thus it becomes possible to efficiently prevent the generation of the damaged portions.

### Advantage of the Invention

According to the present invention, it is possible to realize a fuel cell generator capable of reducing or repairing damage in damaged portions for itself and a method for operating the fuel cell generator.

### BRIEF DESCRIPTION OF THE DRAWINGS

FIG. 1 is a schematic configuration view of a fuel cell generator according to a first embodiment of the present invention.

FIG. 2 is a schematic configuration view of a fuel cell module according to the first embodiment of the present invention.

FIG. 3 is a schematic sectional view of a cell tube according to the first embodiment of the present invention.

FIG. 4 is a schematic sectional view of the cell tube according to the first embodiment of the present invention.

FIG. 5A is a flowchart illustrating an example of the operation conditions of the fuel cell generator according to the first embodiment of the present invention.

FIG. 5B is a flowchart illustrating another example of the operation conditions of the fuel cell generator according to the first embodiment of the present invention.

FIG. 5C is a flowchart illustrating still another example of the operation conditions of the fuel cell generator according to the first embodiment of the present invention.

FIG. 5D is a flowchart illustrating far still another example of the operation conditions of the fuel cell generator according to the first embodiment of the present invention.

FIG. 6 is a schematic sectional view of a cell tube according to a second embodiment of the present invention.

FIG. 7 is a schematic sectional view of a cell tube according to a third embodiment of the present invention.

FIG. 8 is a schematic sectional view of another cell tube according to the third embodiment of the present invention.

FIG. 9 is a schematic sectional view illustrating another example of the cell tube according to the third embodiment of the present invention.

FIG. 10 a schematic sectional view illustrating still another example of the cell tube according to the third embodiment of the present invention.

### BEST MODE FOR CARRYING OUT THE INVENTION

Hereinafter, embodiments of the present invention will be described in detail with reference to the accompanying drawings. Meanwhile, the present invention is not limited to the respective embodiments described below and can be carried out in an appropriately-modified manner. In addition, the respective embodiments described below can be carried out in an appropriate combination. In addition, constituent elements common to the respective embodiments will be given the same reference numbers and the description thereof will not be repeated.

### First Embodiment

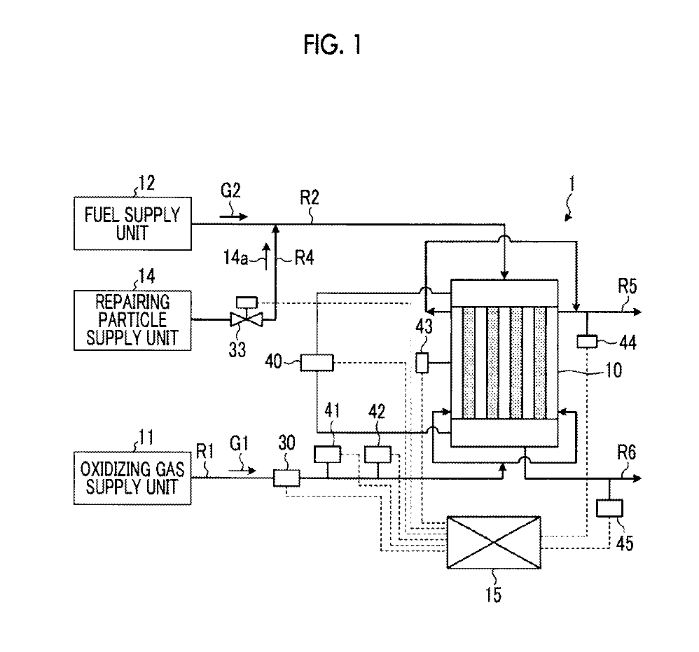

FIG. 1 is a schematic configuration view of a fuel cell generator 1 according to a first embodiment of the present invention. As illustrated in FIG. 1, the fuel cell generator 1 includes a fuel cell module 10 made up of solid oxide fuel cell (SOFC), an air supply unit (oxidizing gas supply unit) 11 that supplies air (oxidizing gas) to the fuel cell module 10, a fuel supply unit 12 that supplies fuel gas to the fuel cell module 10, a repairing particle supply unit 14 that supplies repairing particles to the fuel gas, and a control unit 15 that controls the respective units in the fuel cell generator 1.

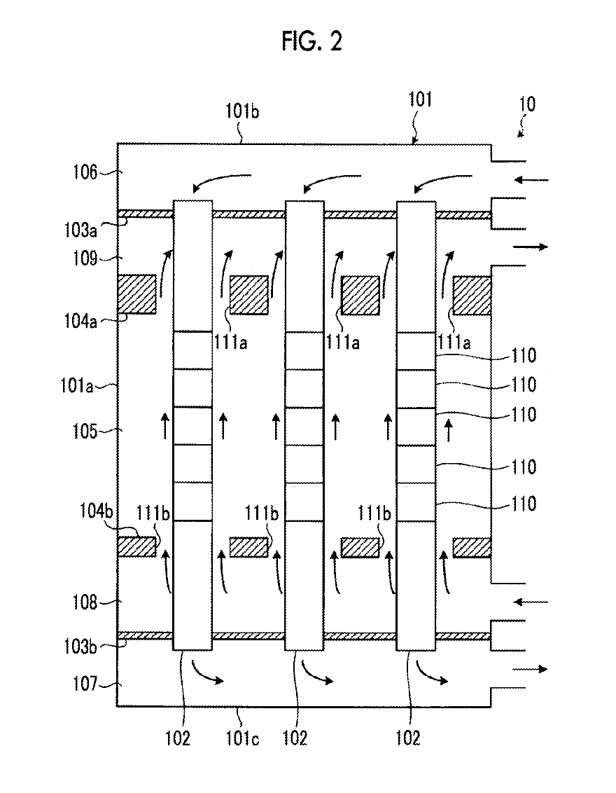

The air supply unit 11 supplies air G₁ as oxidizing gas to an air supply chamber 108 (not illustrated in FIG. 1, refer to FIG. 2) in the fuel cell module 10. The air supply unit 11 and the air supply chamber 108 are connected to each other through an air supply flow path R1. In the air supply flow path R1, an air flow rate meter 30 that measures the flow rate of air flowing through the air supply flow path R1 is provided. The oxidizing gas may be gas containing approximately 15% to 30% of oxygen and the air supply unit 11 may supply, in addition to air, a gas mixture of combustion exhaust gas and air, a gas mixture of oxygen and air, or the like to the fuel cell module 10 as the oxidizing gas.

The fuel supply unit 12 supplies fuel gas G₂ to a fuel supply chamber 106 (not illustrated in FIG. 1, refer to FIG. 2) in the fuel cell module 10. The fuel supply unit 12 and the fuel supply chamber 106 are connected to each other through a fuel supply flow path R2. Liquefied natural gas (LNG), hydrocarbon gas such as hydrogen (H₂) and carbon monoxide (CO) or methane (CE₄), or gas produced using a gasification facility of a carbonaceous raw material such as coal is supplied as the fuel gas G₂.

The repairing particle supply unit 14 supplies repairing particles 14a to the fuel as G₂, which is supplied to the fuel cell module 10 from the fuel supply unit 12, through a repairing particle supply flow path R4. The repairing particles 14a are significantly affected by a buoyant force rather than gravitational settling and, in order to suspend the repairing particle in the fuel as C₂, the ordinary upper limit of the particle diameter is, for example, PM2.5 in terms of the particle diameter of a suspended substance in the air. In addition, the repairing particles 14a are made up of the submicron particles of the repairing particles 14a having an average particle diameter of 2.5 μm or less. In addition, the lower limit value of the average particle diameter of the repairing particles 14a is, for example, 1 nm or more. The repairing particles 14a are supplied to the inside of the fuel cell module 10 together with the fuel gas G₂ and repair damaged portions (for example, fissures and the like) generated in fuel cells 110 (not illustrated in FIG. 1, refer to FIG. 2) in the fuel cell module 10.

The repairing particles 14a contain the submicron particles and are thus likely to agglomerate together. When the repairing particles are suspended in carrier gas after removing adsorbed water vapor and the like through preheating and neutralization and then are diluted before being supplied to the inside of the fuel cell module 10, it is possible to prevent the agglomeration. In addition, when gas is circulated through voids among the particles through fluidized agglomerate so as to drag the particles, the particles are put into a zero-gravity state so as to change all of the particles to behave like liquid, and then the repairing particles 14a are supplied, it becomes possible to prevent the agglomeration.

The repairing particles 14a are at least partially gasified at a temperature that is equal to or higher than the temperature (for example, 800° C. to 950 C.) of an interconnector or a solid electrolyte during the repairing operation of the fuel cell module 10. Therefore, the repairing particles 14a are gasified in the fuel cells 110, reach the damaged portions, and are precipitated in a solid form due to the difference in the oxygen partial pressure between a fuel electrode and an air electrode, whereby it becomes possible to block fissures and the like generated in the damaged portions. In addition, when the amount of gas leakage in the damaged portions is reduced, the temperature decreases, a molten substance changes to a solid, and it becomes possible to reduce and repair damage in the damaged portions. Meanwhile, the repairing operation mentioned herein refers not only to a repairing operation carried out during the power generation of the fuel cell module 10, the details of which will be described below, but also to a repairing operation carried out using the repairing particles 14a under maintenance conditions in which the power generation of the fuel cell module 10 is stopped.

As the repairing particles 14a, a substance which at least partially changes to a liquid or a gas at the temperature of the interconnector or the solid electrolyte during the repairing operation of a power generation unit 105 (not illustrated in FIG. 1, refer to FIG. 2) in the fuel cell module 10 and has a vapor pressure is used. As the repairing particles 14a, it is possible to use typical metal elements or compounds of a transition metal element and a typical non-metal element. The repairing particles 14a are preferably substances which are oxidized in an oxidizing atmosphere and change the phase from gas to solid in a reducing atmosphere. Examples of the repairing particles 14a include NaCl, EnCl₂, and the like. In addition, as the repairing particles 14a, when a eutectic reaction is used by mixing multiple compounds of a typical metal element, a transition metal element, and a typical non-metal element, it is also possible to use a mixture of KCl-NaCl or the like having a melting point that is decreased to be lower than that of a sole compound. A substance having a low reactivity with a material configuring the cell stack of the fuel cell module 10 is preferred. The repairing particles 14a are preferably, for example, at least one selected from a group consisting of sodium carbonate (NaCO₃), sodium chloride (NaCl), zinc chloride (ZnCl₂), sodium fluoride (NaF), and sodium silicate.

Examples of a method for producing the repairing particles 14a include a method for producing the repairing particles 14a having a submicron (several hundred nanometers) size by crushing the repairing particles synthesized using a solid phase method, a liquid phase method, or a gas phase method. In the solid phase method, it becomes possible to obtain the repairing particles 14a having a submicron size by crushing the repairing particles 14a using a ball mill or the like after the synthesis of the repairing particles 14a. In the liquid phase method, it becomes possible to obtain the nano-sized repairing particles 14a using a coprecipitation method, a sol-gel method, a liquid-phase reduction method, a hydrothermal method, or the like. In addition, in the gas phase method, it becomes possible to obtain the nano-sized repairing particles 14a using an electric furnace method, a chemical flame method, a laser method, a thermal plasma method, or the like. Among these, the repairing particles 14a are preferably produced using the liquid phase method from the viewpoint of the manufacturing costs, qualities, and the like. In addition, the average particle diameter of the repairing particles 14a is preferably 1 μm or less. Meanwhile, in the present embodiment, the average particle diameter refers to the average particle diameter (the 50% diameter in the volume-based volume fraction) measured using a measurement method based on JIS R 1629 “Determination of particle size distributions for fine ceramic raw powders by laser diffraction and scattering method”.

In addition, the fuel cell generator 1 includes a voltage meter 40 that measures the voltage of a current in the fuel cell module 10, a first temperature sensor 41 and a second temperature sensor 42 provided in the air supply flow path R1, a third temperature: sensor 43 provided in a power generation chamber 105 in the fuel cell module: 10, an oxygen concentration meter 44 provided in an air discharge flow path R5 in the fuel cell module 10, and a gas concentration meter 45 provided in a fuel gas discharge flow path R6 in the fuel cell module 10.

The voltage meter 40 measures the voltage of a current obtained through the power generation of the fuel cell module 10. The first temperature sensor 41 is provided in the air supply flow path R1. The first temperature sensor 41 measures the temperature of air flowing through the air supply flow path R1. The second temperature sensor 42 is provided downstream of the converging portion of a supply flow path for fuel gas for combustion R3 connected to the air supply flow path R1. The second temperature sensor 42 measures the temperatures of air and fuel gas for combustion which are mixed together downstream of the air supply flow path R1.

The third temperature sensor 43 measures the temperature of the power generation chamber 105 in the fuel cell module 10. The oxygen concentration meter 44 measures the concentration of oxygen in the air discharged from the fuel cell module 10. The gas concentration meter 45 measures the concentration of the fuel gas in the fuel as G₂ discharged from the fuel cell module 10.

To a control unit 15, the air flow rate meter 30, the voltage meter 40, the first temperature sensor 41, the second temperature sensor 42, the third temperature sensor 43, the oxygen concentration meter 44, and the gas concentration meter 45, which have been described, are connected. The control unit 15 controls the respective units in the fuel cell generator during the initiation operation and the power generation operation of the fuel cell module 10. In addition, the control unit 15 controls the supplied amount of the repairing particles 14a that are supplied to the fuel gas G₂ from the repairing particle supply unit 14 through a control valve 33.

FIG. 2 is a schematic configuration view of the fuel cell module 10. As illustrated in FIG. 2, the fuel cell module 10 includes a casing 101, multiple cell tubes 102 that are disposed in the casing 101 and are formed into a substantially cylindrical shape, an upper tube plate 103a supporting the upper end portions of the cell tubes 102, a lower tube plate 103b supporting the lower end portions of the cell tubes 102, and an upper adiabatic body 104a and a lower adiabatic body 104b disposed between the upper and lower tube plates 103a and 103b.

The casing 101 includes a trunk case 101a and an upper case 101b and a lower case 101c provided at both ends of the trunk case 101a. The cell tubes 102 are stored in an interior storage space of the casing 101.

The upper tube plate 103a is a plate-like member disposed on one side (upper side) of the casing 101 in the shaft direction. The lower tube plate 103b is a plate-like member disposed on the other side (lower side) of the casing 101 in the shaft direction. In a space partitioned by the upper case 101b and the upper tube plate 103a of the casing 101, the fuel supply chamber 106 is formed. In a space partitioned by the lower case 101c and the lower tube plate 103b of the casing 101, a fuel discharge chamber 107 is formed. The opening ends of the cell tubes 102 on one side are disposed in the fuel supply chamber 106 and the opening ends of the cell tubes 102 on the other side are disposed in a fuel discharge chamber 107.

The upper adiabatic body 104a is disposed on one side (upper side) of the casing 101 in the shaft direction. The upper adiabatic body 104a is formed into a blanket shape or a board shape using an adiabatic material. The lower adiabatic body 104b is disposed on the other side (lower side) of the casing 101 in the shaft direction. The lower adiabatic body 104b is formed into a blanket shape or a board shape using an adiabatic material. In the respective adiabatic bodies 104a and 104b, holes 111a and 111b, through which the cell tubes 102 are inserted, are formed respectively. The holes 111a and 111b are formed to have a diameter that is larger than the diameter of the cell tube 102. In a space sandwiched by the upper adiabatic body 104a and the lower adiabatic body 104b, the power generation chamber 105 is formed. In addition, in a space between the lower tube plate 103b and the lower adiabatic body 104b, an air supply chamber 108 is formed and in a space between the upper tube plate 103a and the upper adiabatic body 104a, an air discharge chamber 109 is formed. The fuel cells 110 in the cell tube 102s are disposed so as to be located only in the power generation chamber 105.

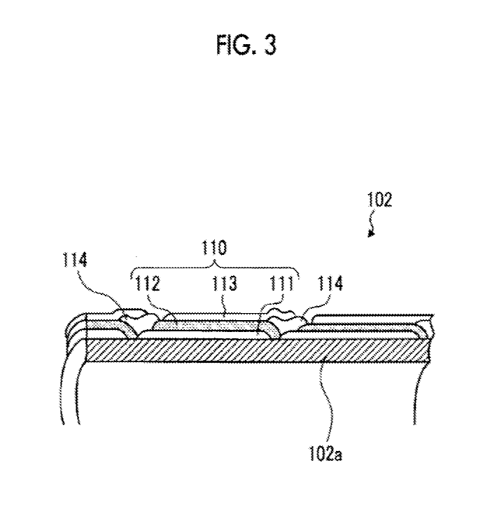

FIG. 3 is a schematic sectional view of the cell tube 102. As illustrated in FIG. 3, the cell tube 102 includes a base body tube 102a forming a cylindrical shape and the fuel cell 110 which serves as a power generation element provided on the outer circumferential surface of the base body tube 102a. The base body tube 102a is a porous ceramic cylindrical tube. Inside the base body tube 102a, the fuel gas G₂ flows. In addition, the base body tube 102a is porous and thus guides the fuel gas G₂ flowing therein to the outer circumferential surface of the base body tube 102a.

The fuel cell 110 of the present embodiment is configured by stacking a fuel electrode 111, a solid electrolyte 112, an interconnector 114, and an air electrode 113 together. The fuel electrode 111 is provided on one surface of the solid electrolyte 112. The air electrode 113 is provided in on the other surface of the solid electrolyte 112. The fuel electrode 111 is in contact with the outer circumferential surface of the base body tube 102a. The air electrode 113 includes active metal. The air electrode 113 has a function (combustion through a catalytic action) that contributes to a combustion reaction using the active metal included therein.

In addition, the multiple fuel cells 110 are disposed along the shaft direction of the base body tube 102a at predetermined intervals. In the multiple fuel cells 110, the fuel electrode 111 of one of the adjacent fuel cells 110 and the air electrode 113 of the other of the adjacent fuel cells 110 are connected to each other through the interconnector 114. The fuel cells 110 configured as described above generate power at a high temperature of, for example, 800° C. to 950° C. during the power generation operation of the fuel well generator 1.

The base body tube 102a is a ceramic cylinder and includes an iron group metal having an internal reforming function (for example, Ni), an iron group metal oxide (for example, NiO), an alloy and an alloy oxide thereof. The base body tube 102a is, for example, a mixture of Ni and CSZ (calcia stabilized zirconia (CaO stabilized ZrO₂)). In addition, the base body tube 102a forms a fuel passage with the inner circumferential surface. The base body tube 102a is configured using a porous material and transmits the fuel gas flowing through the fuel passage to the fuel electrode 111. The base body tube 102a can be made to be porous by adjusting the particle diameters of the mixture or mixing a pore material in.

The fuel electrode 111 is configured using, for example, a mixture of Ni and YSZ (yttrium stabilized zirconia (Y₂O₃ stabilized ZrO₂)). The fuel electrode 111 is electrically conductive and is a porous material. The solid electrolyte 112 is stacked on the surface of the fuel electrode 111 opposite to the base body tube 102a and is formed so as to be present up to a portion between the fuel electrode and another fuel electrode 111 adjacent to each other in the shaft direction of the base body tube 102a. The fuel electrode 111 is configured using an oxide of a compound material between Ni and a zirconia-based electrolytic material, which is, for example, Ni-YSZ. In the fuel electrode 111, Ni, which is a component of the fuel electrode 111, has a catalytic action with respect to the fuel gas G₂. This catalytic action causes a reaction of the fuel gas G₂ supplied through the base body tube 103, for example, a gas mixture of methane (CH₄) and water vapor, and reforms the fuel gas into hydrogen (H₂) and carbon monoxide (CO). In addition, the fuel electrode 111 makes the hydrogen (H₂) and the carbon monoxide (CO) obtained through the reforming electrochemically react with oxygen ions supplied through the solid electrolyte 112 near the interface with the solid electrolyte 112 so as to generate water (H₂O) and carbon dioxide (CO₂). The fuel cells 110 generate power using electrons discharged from the oxygen ions.

The solid electrolyte 112 is configured using, for example, YSZ (yttrium stabilized zirconia (Y₂O₃ stabilized ZrO₂)). A dense material is used in order to prevent the contact between the fuel electrode gas and the air electrode gas. As the solid electrolyte 112, YSZ having airtightness so that gas does not easily pass therethrough and high oxygen ion conductivity at a high temperature is mainly used. The solid electrolyte 112 moves oxygen ions (O²⁻) generated in the air electrode 113 to the fuel electrode 111.

The air electrode 113 is configured using, for example, at least one porous conductive ceramic such as a LaMnO₃-based material, a LaFeO₃-based material, and a LaCoO₃-based material. The air electrode 113 dissociates oxygen in air G₁, which serves as an oxidizing gas being supplied, so as to generate oxygen ions (O²⁻) near the interface with the solid electrolyte 112. In addition, the air electrode 113 has a function (combustion through a catalytic action) that contributes to a combustion reaction. When the fuel gas G₂ is supplied to the air electrode 113, the fuel gas G₂ catalytically combusts in the air electrode 113. The air electrode 113 is catalyst having a power generation function and is also a catalyst having a combustion function including an oxidation reaction.

The interconnector 114 is configured using a conductive perovskite oxide expressed by M₁₋ₓLₓTiO₃ (M represents an alkaline-earth metal element and L represents a lanthanoid element) such as SrTiO₃ and is made of a dense material in order to prevent the leakage of gas. The interconnector 114 is made of a dense film so as to prevent the fuel gas G ₂ and the air G₁ from being mixed together. In addition, the interconnector 114 has stable electric conductivity in both an oxidizing atmosphere and a reducing atmosphere. The interconnector 114 electrically connects, in the fuel cells 110 adjacent to each other, the air electrode 113 in one fuel cell 110 and the fuel electrode 111 in the other fuel cell 110 and connects the fuel cells 110 adjacent to each other in series.

In order to configure the cell tube 102, in the fuel cells 110 adjacent to each other in the shaft direction of the base body tube 102a, the fuel electrode 111 in one fuel cell 110 and the air electrode 113 in the other fuel cell 110 are connected to each other through the interconnector 114. In addition, the fuel electrode 111 is partially coated with the solid electrolyte 112 and is partially coated with the interconnector 114. In addition, the cell tube 102 is sintered in a state in which the fuel electrode 111, the solid electrolyte 112, the interconnector 114, and the air electrode 113 are stacked on the exterior surface of the base body tube 102a.

Here, the overall operation of the fuel cell module 10 will be described. The fuel cell module 10 carries out an initiation operation through which the fuel cells 110 are heated to a predetermined temperature and then carries out a power generation operation through which power is generated in the fuel cells 110. When the fuel cell module 10 carries out the power generation operation, the air G₁ into the air supply chamber 108 in the fuel cell module 10. This air G₁ is supplied to the inside of the power generation chamber 105 through the gaps between the holes 111b in the lower adiabatic body 104b and the cell tube 102. On the other hand, the fuel gas G₂ flows into the fuel supply chamber 106. This fuel gas G₂ is supplied to the inside of the power generation chamber 105 through the inside of the base body tube 102a in the cell tube 102. Here, the air G₁ and the fuel gas G₂ flow in the mutually opposite directions on the inner circumferential surface and the outer circumferential surface of the cell tube 102.

The fuel gas G₂ flowing inside the base body tube 102a passes through fine holes in the base body tube 102a and reaches the fuel electrode 111. The fuel gas G₂ is reformed into water vapor using the active metal included in the fuel electrode 111. Hydrogen generated through the water vapor reforming passes through fine holes in the fuel electrode 111 and reaches the solid electrolyte 112. On the other hand, the air G₁ flows along the outside of the base body tube 102a (the air electrode 113). Oxygen in the air ionizes while passing through fine holes in the air electrode 113 or after reaching the solid electrolyte 112. The ionized oxygen passes through the solid electrolyte 112 and reaches the fuel electrode 111. The oxygen ions that have passed through the solid electrolyte 112 react with the fuel gas G₂. The fuel cell module 10 generates power due to the potential difference generated by the above-described cell reaction.

In addition, the fuel gas G₂ that is used for power generation in the power generation chamber 105 and thus has a high temperature exchanges heat with the air G₁ that is to he used for power generation in the air supply chamber 108. In addition, the air G₁ that is used for power generation in the power generation chamber 105 and thus has a hide temperature exchanges heat with the fuel as G₂ that is to be used for power generation in the air discharge chamber 109.

In addition, after the fuel gas G₂ and the air G₁ that have been used for power generation are cooled through the heat exchange, the fuel gas G₂ flows into the fuel discharge chamber 107 and is discharged outside the fuel cell module 10 from the fuel discharge chamber 107. The air G₁ is discharged outside the fuel cell module 10 from the air discharge chamber 109.

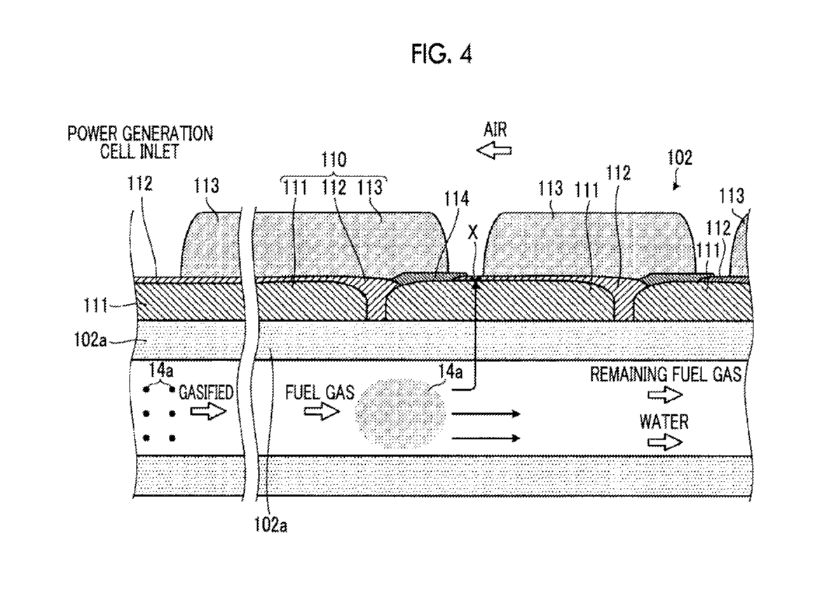

Next, a repairing operation of the fuel cell 110 in the fuel cell generator 1 according the present invention will he described. FIG. 4 is a schematic sectional view of the cell tube 102 according to the present embodiment.

As illustrated in FIG. 4, during the operation of the fuel cell generator 1, the fuel gas G₂ is supplied to the inside of the base body tube 102a, remaining fuel gas and water are generated, and the air G₁ flows outside the base body tube 1 02a. Here, in a case in which there are defective portions such as pinholes in the solid electrolyte 112, which is a dense film, and the interconnector 114 in the fuel cell 110, there are cases in which oxygen contained in the air G₁ intrudes into the fuel electrode 111 through the defective portions due to the leakage caused by the differential pressure between the fuel electrode 111 and the air electrode 113 and the diffusion caused by the difference in the concentration of oxygen between the fuel electrode 111 and the air electrode 113, nickel (Ni) in the fuel electrode 111 oxidizes and thus turns into nickel oxide (NiO), and the volume of a partial region of the fuel electrode 111 expands. In this case, there are cases in which compressive stress is generated in another region of the fuel electrode 111 and thus a tensile stress is generated on the inner surfaces of the electrolyte 112, the interconnector 114, and the base body tube 102a, when the generated tensile stress is greater than the fracture stress, fissures and the like are generated, and thus damaged portions X are generated.

In the present embodiment, the repairing particles 14a are supplied to the fuel cells 110 together with the fuel gas G₂ flowing inside the base body tube 102a. The supplied repairing particles 14a are at least partially gasified at the temperature or higher (for example, 800° C. to 950° C.) of the interconnector 114 or the solid electrolyte 112 during the repairing operation. In addition, the gasified repairing particles 14a pass through the base body tube 102a configured using a porous ceramic material or the like and reach the damaged portions X in the fuel cells 102. Furthermore, the damaged portions X are in a state in which the oxygen partial pressure in the fuel is higher than that in the fuel electrode 111 in a reducing atmosphere due to the leakage of oxygen from the air electrode 113 caused by the differential pressure between the fuel electrode 111 and the air electrode 113 and the diffusion of oxygen caused by the difference in the concentration of oxygen between the fuel electrode 111 and the air electrode 113, and the gasified repairing particle component of the repairing particles 14a that have reached the damaged portions X is oxidized at the oxygen partial pressure of the damaged portions X and is precipitated in a solid form. Therefore, it is possible to at least partially block the damaged portions X, which serve as the routes for the leakage of oxygen from the air electrode 113 to the fuel electrode 111, with the precipitated solid and the leakage amount of oxygen is reduced.

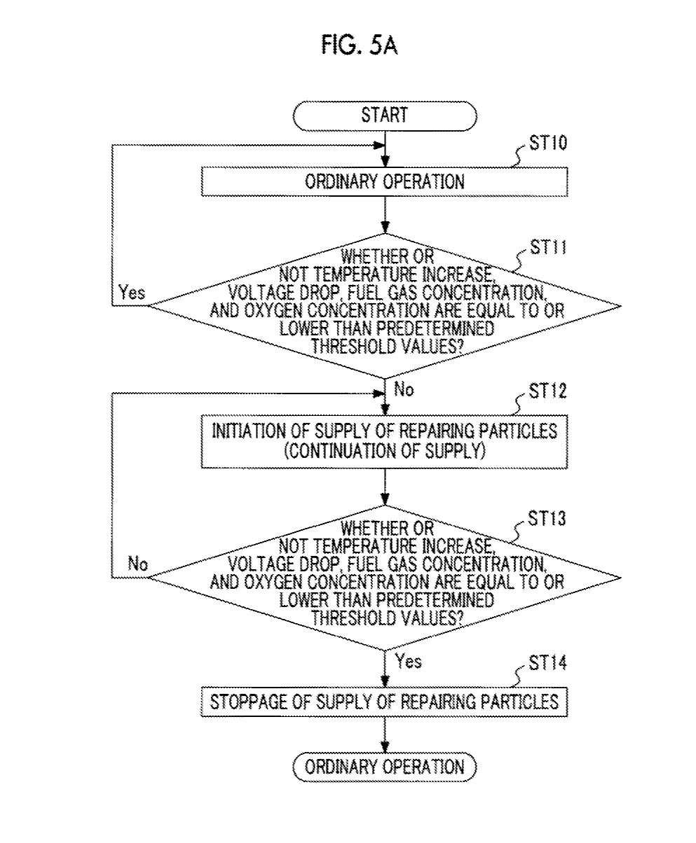

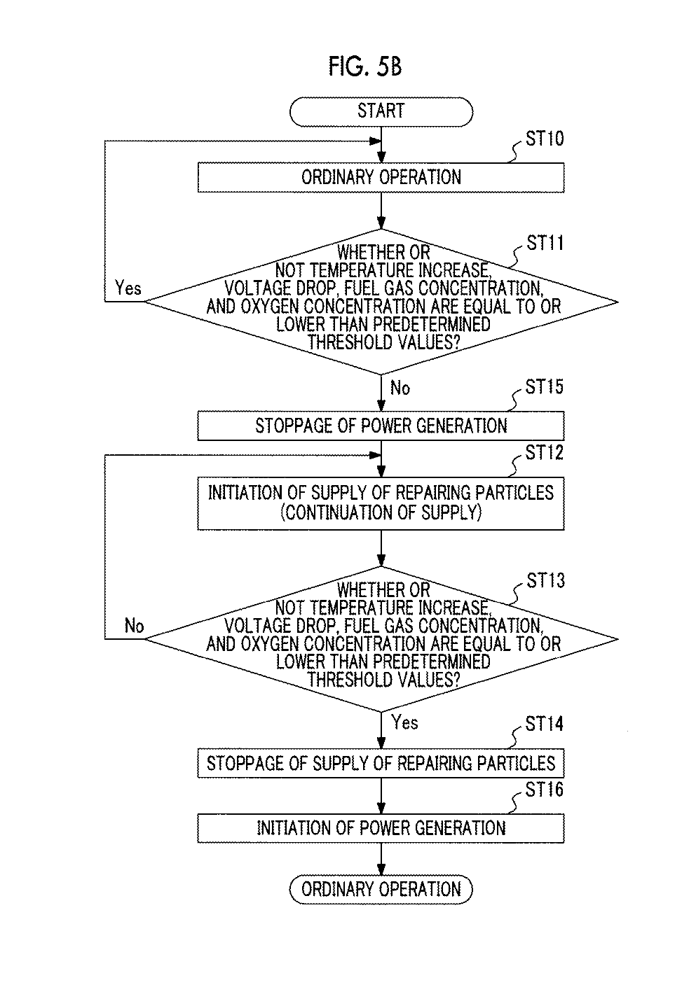

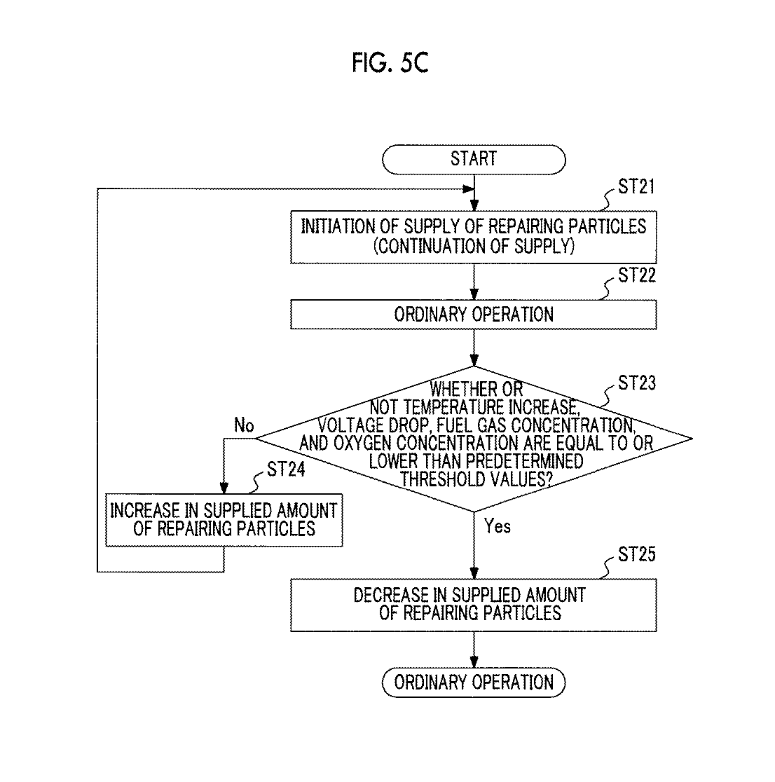

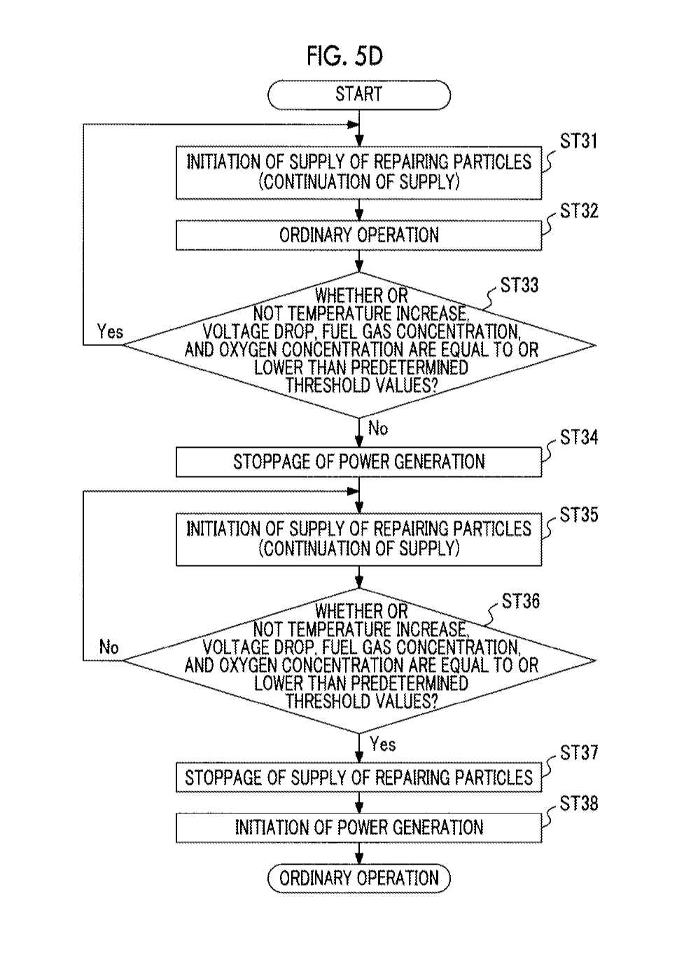

Next, a method for operating a fuel cell according to the present embodiment will be described in detail with reference to FIGS. 5A and 5B. FIG. 5A is a flowchart illustrating an example of the method for operating the fuel cell according to the present embodiment. As illustrated in FIG. 5A, first, the control unit 15, after an ordinary operation of the fuel cell generator 1 (Step ST10), determines whether or not a variety of measurement values related to an increase in the temperature of the fuel cell module 10 measured using the third temperature sensor 43 (for example, 25° C.), the concentration of the fuel gas in the fuel gas discharged from the fuel cell module 10 measured using the gas concentration meter 45, the voltage drop of the fuel cell module 10 measured using the voltage meter 40, and the concentration of oxygen in the air discharged from the fuel cell module 10 measured using the oxygen concentration meter 44 are equal to or lower than the predetermined threshold values (Step ST11). In addition, in a case in which the variety of measurement values are equal to or lower than the predetermined threshold values (Step ST11: Yes), the control unit 15 continues the ordinary operation of the fuel cell module 10. In addition, in a case in which the variety of measurement values exceed the predetermined threshold values (Step ST11: No), the control unit 15 initiates the supply of the repairing particles 14a from the repairing particle supply unit 14 to the fuel cell module 10 (Step ST12). Therefore, the repairing particles 14a are gasified, reach the damaged portions X, and are precipitated as illustrated in FIG. 4 and thus the fuel cell module 10 becomes capable of repairing fissure and the like in the damaged portions X. The repairing particles 14a that do not contribute to the repair are precipitated in a low-temperature section other than the fuel cells 110. Therefore, the repairing particles are collected by installing a filter at the pipe in the fuel outlet or collected by accelerating the condensation from a gas phase using a cooling trap.

In addition, the control unit 15, again, determines whether or not the variety of measured measurement values are equal to or lower than the predetermined threshold values and, in a case in which the variety of measurement values are equal to or lower than the predetermined threshold values (Step ST13: Yes), the supply of the repairing particles 14a from the repairing particle supply unit 14 is stopped so as to continue the ordinary operation of the fuel cell module 10 (Step ST14). Here, the control unit 15 may make only the fuel gas G₂ flow for a predetermined time without conducting electricity after the end of the supply of the repairing particles. Therefore, the repairing particles 14a remaining in the fuel cell module 10 can be discharged and thus it becomes possible to clean the fuel cell module 10. In addition, in a case in which the variety of re-measured measurement values exceed the predetermined threshold values (Step ST13: No), the control unit 15 continues the supply of the repairing particles 14a from the repairing particle supply unit 14 and operates the fuel cell module 10 (Step ST12).

FIG. 5B is a flowchart illustrating another example of the method for operating the fuel cell generator according to the present embodiment. In the example illustrated in FIG. 5B, in a case in which a variety of measurement values measured using the third temperature sensor 43, the gas concentration meter 45, the voltage meter 40, and the oxygen concentration meter 44 exceed the predetermined threshold values (Step ST11: No), the control unit 15 stops the supply of the air G₁ and the fuel gas G₂ to the fuel cell module 10 so as to stop the power generation of the fuel cell module 10 (Step ST15). Therefore, even in a case in which the damaged portions X such as fissures and the like in the interconnector 114, the solid electrolyte 112, and the like are large, it is possible to prevent an excessive increase in the temperature of the fuel cell module 10 and thus it becomes possible to efficiently repair and reduce damage for itself using the repairing particles 14a. After the repairing operation of the damaged portions X, the control unit 15 reinitiates the supply of the air G₁ and the fuel gas G₂ to the fuel cell module 10 so as to initiate power generation (Step ST16) and then operates the fuel cell module 10 in an ordinary manner.

FIG. 5C is a flowchart illustrating still another example of the method for operating the fuel cell according to the present embodiment. In the example illustrated in FIG. 5C, first, the control unit 15 initiates the supply of the repairing particles 14a from the repairing particle supply unit 14 to the fuel cell module 10 before the initiation of the operation (Step ST21). Subsequently, the control unit 15 initiates the ordinary operation of the fuel cell module 10 in a state in which the supply of the repairing particles 14a from the repairing particle supply unit 14 to the fuel cell module 10 is continued (Step ST22). Next, the control unit 15 determines whether or not a variety of measurement values related to an increase in the temperature of the fuel cell module 10 measured using the third temperature sensor 43 (for example, 25° C., the concentration of the fuel gas in the fuel gas discharged from the fuel cell module 10 measured using the gas concentration meter 45, the voltage drop of the fuel cell module 10 measured using the voltage meter 40, and the concentration of oxygen in the air discharged from the fuel cell module 10 measured using the oxygen concentration meter 44 are equal to or lower than the predetermined threshold values (Step ST23) In addition, in a case in which the variety of measurement values exceed the predetermined threshold values (Step ST23: No), the supplied amount of the repairing particles 14a from the repairing particle supply unit 14 to the fuel cell module 10 is increased (Step ST24). Therefore, the repairing particles 14a are gasified, reach the damaged portions X, and are precipitated as illustrated in FIG. 4 and thus the fuel cell module 10 becomes capable of repairing fissures and the like in the damaged portions X. The repairing particles 14a that do not contribute to the repair are precipitated in a low-temperature section other than the fuel cells 110. Therefore, the repairing particles are collected by installing a filter at the pipe in the fuel outlet or collected by accelerating the condensation from a as phase using a cooling trap. In addition, in a case in which the variety of measurement values are equal to or lower than the predetermined threshold values (Step ST23: Yes), the control unit 15 decreases the supplied amount of the repairing particles 14a from the repairing particle supply unit 14 and continues the ordinary operation of the fuel cell module 10 (Step ST25). Therefore, the method for operating the fuel cell can supply the repairing particles 14a to the interconnector 114, the solid electrolyte 112, and the like in the fuel cell module 10 at all times and thus it becomes possible to efficiently prevent the generation of the damaged portions X.

FIG. 5D is a flowchart illustrating far still another example of the method for operating the fuel cell according to the present embodiment. In the example illustrated in FIG. 5D, first, the control unit 15 initiates the supply of the repairing particles 14a from the repairing particle supply unit 14 to the fuel cell module 10 before the initiation of the operation (Step ST31). Subsequently, the control unit 15 operates the fuel cell module 10 in an ordinary manner in a state in which the repairing particles 14a are supplied to the fuel cell module 10 from the repairing particle supply unit 14 (Step ST32). Next, in a case in which a variety of measurement values measured using the third temperature sensor 43, the gas concentration meter 45, the voltage: meter 40, and the oxygen concentration meter 44 exceed the predetermined threshold values (Step ST33: No), the control unit 15 stops the supply of the air G₁ and the fuel gas G₂ to the fuel cell module 10 and stops the power generation of the fuel cell Module 10 (Step ST34). Therefore, even in a case in which the damaged portions X such as fissures and the like in the interconnector 114, the solid electrolyte 112, and the like are large, it is possible to prevent an excessive increase in the temperature of the fuel cell module 10 and thus it becomes possible to efficiently reduce and repair damage for itself using the repairing particles 14a.

Next, the control unit 15 continues the supply of the repairing particles 14a to the fuel cell module 10 in a state in which the power generation of the fuel cell module 10 is stopped (Step ST35). Here, in a case in which the damaged portions X such as fissures and the like in the interconnector 114, the solid electrolyte 112, and the like are large, the control unit 15 may use the repairing particles 14a that are at least partially melted at a high temperature with respect to the interconnector 114 or the solid electrolyte 112 (for example, 800° C. to 950° C.) during the repairing operation of the fuel cell module 10 according to a second embodiment, the details of which will be described below. Therefore, it is possible to jointly use two kinds of repairing particles 14a having different properties and thus it becomes possible to efficiently repair the damaged portions X. Next, the control unit 15 determines whether or not a variety of measurement values related to an increase in the temperature of the fuel cell module 10 measured using the third temperature sensor 43 (for example, 25° C.) the concentration of the fuel gas in the fuel gas discharged from the fuel cell module 10 measured using the gas concentration meter 45, the voltage drop of the fuel cell module 10 measured using the voltage meter 40, and the concentration of oxygen in the air discharged from the fuel cell module 10 measured using the oxygen concentration meter 44 are equal to or lower than the predetermined threshold values (Step ST36). In addition, in a case in which the variety of measurement values exceed the predetermined threshold values (Step ST36: No), the control unit 15 continues the supply of the repairing particles 14a from the repairing particle supply unit 14 to the fuel cell module 10 (Step ST34). In addition, in a case in which the variety of measurement values are equal to or lower than the predetermined threshold values (Step ST36: Yes), the control unit 15 stops the supply of the repairing particles 14a to the fuel cell module 10 from the repairing particle supply unit 14 so as to end the repairing operation (Step ST37). Subsequently, the control unit 15, after the repairing operation of the damage portions X, reinitiates the supply of the it G₁ and the fuel gas G₂ to the fuel cell module 10 so as to initiate power generation (Step ST38) and then operates the fuel cell module 10 in an ordinary manner. Therefore, in the method for operation the fuel cell, it is possible to supply the repairing particles 14a to the interconnector 114, the solid electrolyte 112, and the like in the fuel cell module 10 at all times from before the initiation of the ordinary operation of the fuel cell module 10 to after the completion of the repairing operation of the fuel cell module 10 and thus it becomes possible to efficiently prevent the generation of the damaged portions X.

As described above, according to the present embodiment, even in a case in which fissures are generated in the fuel cells 110 in the fuel cell module 10, the repairing particles 14a supplied to the fuel gas G₂ are supplied to the fuel cells 110 together with the fuel gas G₂ and thus it is possible to repair the damaged portions X such as fissures generated in the fuel cells 110. Therefore, even in a case in which the fuel cells 110 are damaged due to the generation of fissures, it is possible to realize the fuel cell generator 1 capable of reducing or repairing damage of the damaged portions for itself.

### Second Embodiment

Next, the second embodiment of the present invention will be described. Meanwhile, in the following description, differences from the above-described first embodiment will be mainly described and the repetition of the description will be avoided.

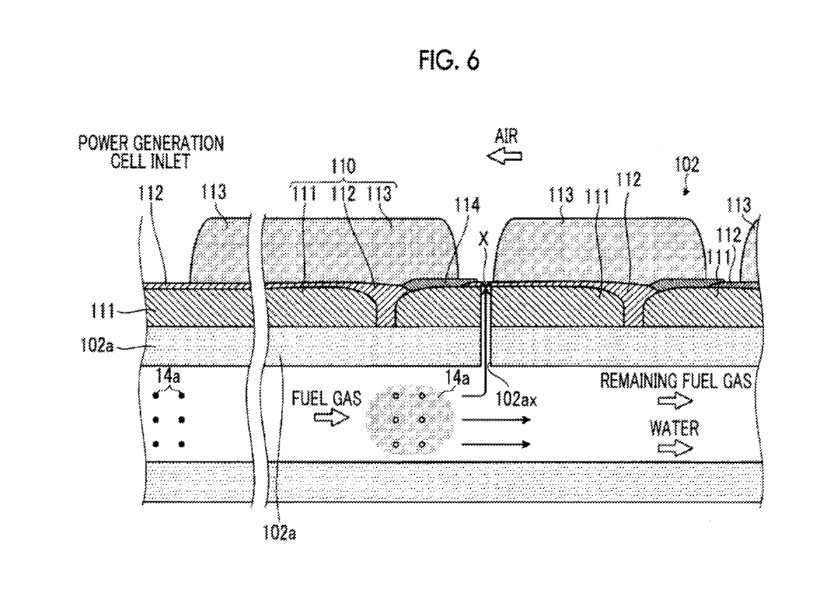

FIG. 6 is a schematic sectional view of the cell tube 102 according to the present embodiment. As illustrated in FIG. 6, in the present embodiment, the repairing particles 14a that are at least partially melted at a high temperature with respect to the interconnector 114 or the solid electrolyte 112 (for example, 800° C. to 950° C.) during the repairing operation of the fuel cell module 10 are used as the repairing particles 14a. Therefore, even in a case in which fissure portions 102ax are generated in the base body tube 102a, the repairing particles 14a are melted near the damaged portions 102X in the fuel electrode 111 having a temperature that is increased due to the leakage of gas, the molten repairing particles 14a intrude toward the fuel electrode 111 from the fissure portions 102ax in the base body tube 102a and reach the damaged portions X. Therefore, the molten repairing particles 14a serve as resistance to the leakage of gas from the damaged portions X caused by a surface tension or the differential pressure between the fuel and the air and thus the amount of gas leakage is slowly decreased. In addition, the temperatures near the damaged portions X are decreased in response to the reduction of the amount of gas leakage and thus it becomes possible to fully block the damaged portions X through the solidification of the molten substance of the repairing particles 14a.

In the present embodiment, the repairing particles 14a are preferably a compound of a typical metal element, a transition metal element, and a typical non-metal element which is at least partially melted at the temperature of the interconnector 114 or the solid electrolyte 112 during the repairing operation of the power generation unit in the fuel cell module 10. Examples of the repairing particles 14a include caicia silicate (CaSi₂), sodium fluoride (NaF), and the like having a melting point of approximately 1000° C. In addition, it is also possible to use SrO—ZnO—P₂O₅, PbO—CrO₃—WO₃, and the like which are mixtures having a melting point that is decreased to be lower than that of a sole compound by mixing multiple compounds of a typical metal element, a transition metal element, and a typical non-metal element and causing a eutectic reaction.

As described above, according to the present embodiment, since the repairing particles 14a having higher melting point than the interconnector 114 or the solid electrolyte 112 during the repairing operation of the fuel cell module 10 are used, the repairing particles 14a are melted near the damaged portions X in the fuel cells 110 having a temperature that is increased due to gas leakage and reach the damaged portions X. Therefore, it becomes possible to block the damaged portions X and thus it becomes possible to efficiently reduce and repair damage in the damaged portions X for itself.

### Third Embodiment

Next, a third embodiment will be described. Meanwhile, in the following description, differences from the above-described first embodiment will be mainly described and the repetition of the description will be avoided.

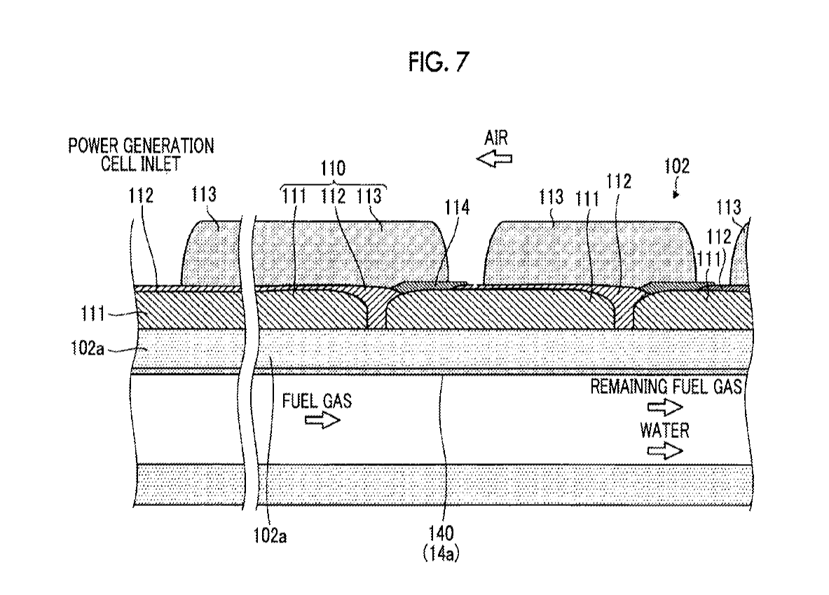

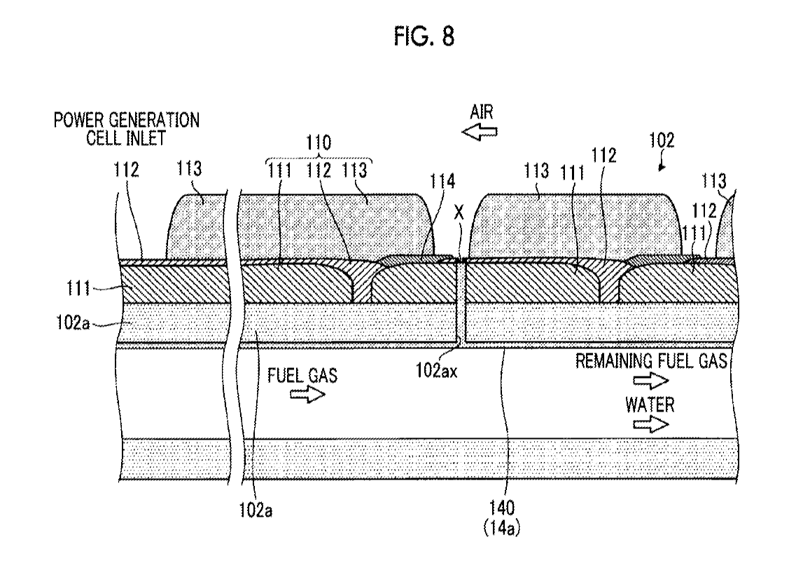

FIG. 7 is a schematic sectional view of the cell tube 102 according to the present embodiment. As illustrated in FIG. 7, in the present embodiment, the repairing particles 14a are applied onto the interior wall of the base body tube 102a in advance so as to provide a repairing particle layer (repairing particle supply chamber) 140 including the repairing particles 14a. Therefore, in a case in which the fissure portions 102ax are generated on the interior wall of the base body tube 102a and the damaged portions X are generated in the fuel cells 110 as illustrated in FIG. 8, the repairing particles 14a in the repairing particle layer 140 intrude into the damaged portions X through the fissure portions 102ax and thus it becomes possible to repair the damaged portions X in the same manner as in the first and second embodiments. The repairing particle layer 140 preferably includes a pore-forming material and the like so as to transmit gas. In addition, the repairing particle layers 140 are preferably particles that are not melted at the operation temperature of the fuel cell module 10 but are melted or gasified at the temperature of the interconnector 114 or the solid electrolyte 112 during the repairing operation. Furthermore, the repairing particle layer 140 preferably has a linear expansion. coefficient (thermal expansion rate) similar to the linear expansion coefficient of a cell stack.

In the present embodiment, as the repairing particles 14a, it is possible to use the same particles as in the second embodiment. In addition, as the repairing particles 14a, a substance that at least partially turns into liquid or gas at the temperature of the interconnector 114 or the solid electrolyte 112 during the repairing operation so as to have a vapor pressure may also be used. Examples of the above-described substance include substances, such as sodium fluoride (NaF), that are compounds of a typical metal element, a transition metal element, and a typical non-metal element, are oxidized in an oxidizing atmosphere, and change the phase from gas to solid in a reducing atmosphere. In addition, a substance having a melting point that is decreased to be lower than that of a sole compound by mixing multiple compounds of a typical metal element, a transition metal element, and a typical non-metal element and causing a eutectic reaction may also be used.

In the method for manufacturing the repairing particle layer 140, a pore-forming material for forming pores among the repairing particles 14a, purified water, and a dispersing material are mixed together and are kneaded using a kneader, thereby producing a slurry. In addition, it is possible to provide the repairing particle. layer 140 by applying the obtained slurry to the inside of the base body tube 102a in a cell stack after the firing of the air electrode or a cell stack after a reducing step through dipping or the like. Examples of the pore-forming material include acrylic particles and styrene particles. In addition, as the dispersing material, it is possible to use a dispersing material for ceramics (product name: POIZ532A manufactured by KAO Corporation) or the like. In addition, the film thickness during the application of the slurry of the repairing particles 14a can be appropriately controlled using the viscosity, yield value, surface tension, and the like of the slurry.

As described above, according to the present embodiment, since the repairing particles 14a are supplied to the damaged portions X generated in the fuel cells 110 from the repairing particle layer 140 provided in advance on the interior wall of the base body tube 102a, even in a case in which the damaged portions X are generated in the fuel cells 110, it becomes possible to repair the damaged portions X for itself.

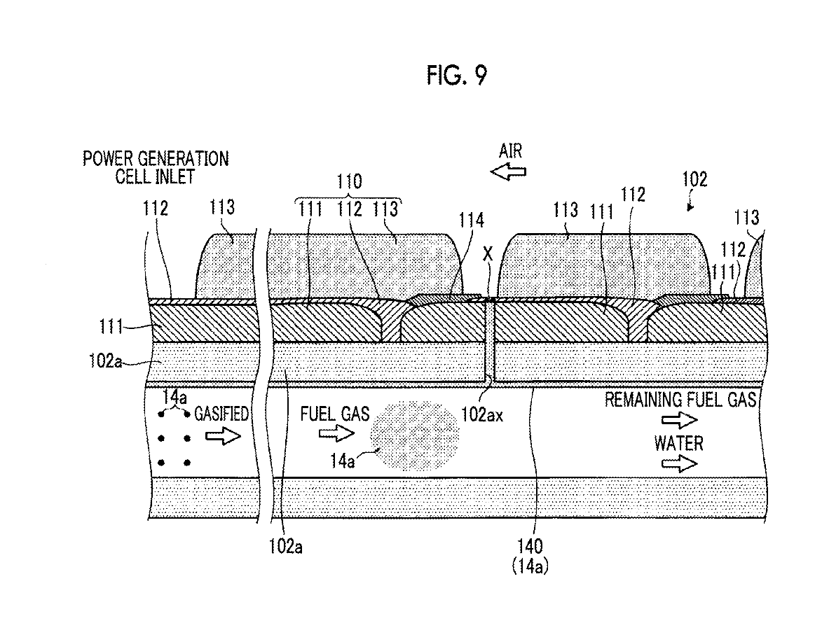

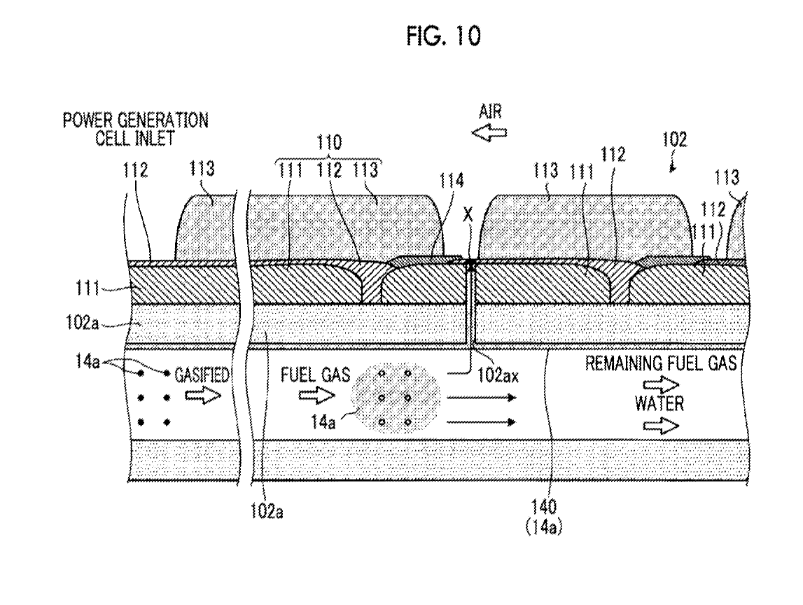

Meanwhile, in the present embodiment, the repairing particles 14a may be supplied from the repairing particle layer 140 provided in the cell tube 102 and, as illustrated in FIGS. 9 and 10, similar to the first and second embodiments, the repairing particles 14a may be supplied from the repairing particle supply unit 14 to the fuel cell as necessary. Therefore, even in a case in which the damaged layers in the damaged portions X are insufficiently reduced due to the insufficient supplied amount of the repairing particles 14a supplied from the repairing particle layer 140, it becomes possible to reduce and repair damage in the damaged portions X in the interconnector 114 and the solid electrolyte 112 for itself using the repairing particles 14a supplied from the repairing particle supply unit 14 together with the fuel gas. In addition, since it also becomes possible to supply the repairing particles 14a that are different from the repairing particles 14a provided in advance in the repairing particle layer 140, it also becomes possible to efficiently repair the damaged portions X which cannot be sufficiently repaired using the repairing particles 14a in the repairing particle layer 140.

Meanwhile, in the respective embodiments described above, an example in which the base body of the fuel cell 110 is the cylindrical base body tube 102a has been described; however, as the base body, it is possible to use not only the cylindrical base body tube 102a but also base bodies having a variety of shapes such as a planar base body tube and a flat-cylindrical base body tube. In addition, the interconnector 114 may be connected in series or in parallel.

In addition, in the respective embodiments described above, an example in which the fuel cells 110 in the fuel cell module 10 are provided on the base body has been described; however, in the fuel cell module 10, the fuel cells 110 do not need to be provided on the base body at all times and a plurality of the fuel cells 110 having the fuel electrode 111, the solid electrolyte 112, and the air electrode 113 sequentially laminated may be disposed adjacent to each other.

### DESCRIPTION OF REFERENCE NUMERALS AND SIGNS

1 FUEL CELL GENERATOR

10 FUEL CELL MODULE

11 AIR SUPPLY UNIT

12 FUEL SUPPLY UNIT

13 SUPPLY UNIT FOR FUEL FOR COMBUSTION

14 REPAIRING PARTICLE SUPPLY UNIT

14a REPAIRING PARTICLE

15 CONTROL UNIT

30 AIR FLOW RATE METER

31 FLOW RATE METER OF FUEL GAS FOR COMBUSTION

32 FLOW RATE ADJUSTMENT VALVE

40 VOLTAGE METER

41 FIRST TEMPERATURE SENSOR

42 SECOND TEMPERATURE SENSOR

43 THIRD TEMPERATURE SENSOR

44 OXYGEN CONCENTRATION METER

45 GAS CONCENTRATION METER

101 CASING

102 CELL TUBE

102a BASE BODY TUBE

105 POWER GENERATION CHAMBER

106 FUEL SUPPLY CHAMBER

107 FUEL DISCHARGE CHAMBER

108 AIR SUPPLY CHAMBER

109 AIR DISCHARGE CHAMBER

110 FUEL CELL

111 FUEL ELECTRODE

112 SOLID ELECTROLYTE

113 AIR ELECTRODE

114 INTERCONNECTOR

140 REPAIRING PARTICLE LAYER

R1 AIR SUPPLY FLOW PATH

R2 FUEL SUPPLY FLOW PATH

R4 REPAIRING PARTICLE SUPPLY FLOW PATH

R5 AIR DISCHARGE FLOW PATH

R6 FUEL GAS DISCHARGE FLOW PATH

G₁ AIR

G₂ FUEL GAS

1. A fuel cell generator, comprising:
a fuel cell main body formed by disposing multiple power generation elements, in which a fuel electrode, a solid electrolyte, and an air electrode are sequentially stacked together, at predetermined intervals, the multiple power generation elements being connected to each other through an interconnector;
a fuel gas supply unit that supplies fuel gas to the fuel electrode;
an oxidizing gas supply unit that supplies oxidizing gas to the air electrode; and
a repairing particle supply unit that supplies repairing particles that repair a damaged portion to the damaged portion in at least one of the interconnector and the solid electrolyte.

2. The fuel cell generator according to claim 1,
wherein the repairing particle supply unit supplies the repairing particles to the fuel gas.

3. The fuel cell generator according to claim 1,
wherein the repairing particle supply unit is a repairing particle layer provided on the surface of a base body provided with the power generation element.

4. The fuel cell generator according to any one of claim 1, comprising:
a control unit that controls the supplied amount of the repairing particles on the basis of an increase in the temperature of the fuel cell base body, the concentration of the fuel gas discharged from the fuel cell base body, the voltage drop of the fuel cell base body, and the concentration of oxygen in oxidizing gas discharged from the fuel cell base body.

5. The fuel cell generator according to any one of claim 1,
wherein the repairing particles are at least partially gasified at a temperature that is equal to or higher than the temperature of the interconnector or the solid electrolyte during the repairing operation of the fuel cell main body through which the damaged portions are repaired.

6. The fuel cell generator according to any one of claim 1,
wherein the repairing particles are at least partially melted at a temperature that is equal to or higher than the temperature of the interconnector or the solid electrolyte during the repairing operation of the fuel cell main body through which the damaged portions are repaired.

7. The fuel cell generator according to any one of claim 1,
wherein the average particle diameter of the repairing particles is 2.5 μm or less.

8. The fuel cell generator according to any one of claim 1,
wherein the repairing particles include at least one selected from a group consisting of sodium carbonate, sodium chloride, zinc oxide, sodium fluoride, and sodium silicate.

9. The fuel cell generator according to any one of claim 1,
wherein the power generation element is provided on a base body tube forming a cylindrical shape.

10. A method for operating a fuel cell generator, comprising:
a first step of measuring at least one of an increase in the temperature of a fuel cell base body, the concentration of fuel gas discharged from the fuel cell base body, the voltage drop of the fuel cell base body, and the concentration of oxygen in oxidizing gas discharged from the fuel cell base body: and
a second step of controlling the amount of repairing particles repairing a damaged portion supplied to the damaged portion in at least one of an interconnector and a solid electrolyte in a power generation element of the fuel cell main body on the basis of at least one measurement value of the measured increase in the temperature, the measured concentration of the fuel gas, the measured voltage drop, and the measured concentration of oxygen.

11. The method for operating a fuel cell generator according to claim 10,
wherein, in a case in which the measurement value exceeds a predetermined threshold value, the supply of the repairing particles is initiated or continued and, in a case in which the measurement value is equal to or lower than the predetermined threshold value, the supply of the repairing particles is stopped.

12. The method for operating a fuel cell generator according to claim 10,
wherein, in the first step, the supply of the repairing particles is initiated in advance before the initiation of the operation of the fuel cell main body and, in the second step, in a case in which the measurement value exceeds the predetermined threshold value, the supplied amount of the repairing particles is increased and, in a case in which the measurement value is equal to or lower than the predetermined threshold value, the supplied amount of the repairing particles is decreased.

13. The method for operating a fuel cell generator according to claim 10,
wherein, in the second step, in a case in which the measurement value exceeds the predetermined threshold value, the power generation of the fuel cell main body is stopped so as to initiate or continue the supply of the repairing particles, and
wherein the method comprises:
a third step of, in a state in which the power generation of the fuel cell main body is stopped, measuring at least one of an increase in the temperature of the fuel cell base body, the concentration of the fuel gas discharged from the fuel cell base body, the voltage drop of the fuel cell base body, and the concentration of oxygen in oxidizing gas discharged from the fuel cell base body; and
a fourth step of initiating or continuing the supply of the repairing particles in a case in which at least one measurement value of an increase in the temperature of the fuel cell base body, the concentration of the fuel gas discharged from the fuel cell base body, the voltage drop of the fuel cell base body, and the concentration of oxygen in oxidizing gas discharged from the fuel cell main body in a state in which the power generation of the fuel cell main body is stopped exceeds the predetermined threshold value, and stopping the supply of the repairing particles in a case in which the measurement value is equal to or lower than the predetermined threshold value.

14. The method for operating a fuel cell generator according to claim 13,
wherein, in the first step, the supply of the repairing particles is initiated in advance before the initiation of the operation of the fuel cell base body.
